(19) United States
(12) Patent Application Publication
(10) Pub. No.: US 2007/0062992 A1
(43) Pub. Date: Mar. 22, 2007

(54) WATER SPORTS EQUIPMENT RACK AND METHODS

(75) Inventors: James Hepworth, Meridian, ID (US); Bryce Adam Hepworth, Boise, ID (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: DBOT5, LLC, Boise, ID (US)

(21) Appl. No.: 11/531,491

(22) Filed: Sep. 13, 2006

Related U.S. Application Data
(60) Provisional application No. 60/717,714, filed on Sep. 16, 2005.

(51) Int. Cl. B60R 7/00; B60R 9/00; B60R 11/00

(52) U.S. Cl. 224/406; 224/917.5; 224/558; 224/564; 224/571

(57) ABSTRACT

Embodiments of the invention provide improved water sports equipment racks and methods for their use. In an set of embodiments, device (such as a rack, for example) for holding one or more pieces of water sports equipment is provided. The rack might have a first pair of forks having parallel prongs adapted to hold one or more water skis, wakeboards, and or the like. In some embodiments, the rack might further comprise a second pair of forks adapted to hold a surfboard. Merely by way of example, each member of the second pair of forks might comprise an upper support surface and a lower support surface disposed approximately parallel with the upper support surface. The upper support surface and lower support surface can be spaces to accommodate a surfboard therebetween. Other embodiments provide methods of using and/or modifying water sports equipment racks.

### CROSS-REFERENCE TO RELATED APPLICATIONS

This application is a nonprovisional of, and claims the benefit of, provisional U.S. Application Ser. No. 60/717,714, filed Sep. 16, 2005 by Hepworth et al. and entitled “Water Sports Equipment Rack and Methods,” the entire disclosure of which is hereby incorporated by reference for all purposes.

### FIELD OF THE INVENTION

The present invention relates sporting equipment in general and in particular to racks for storing and/or transporting sporting equipment.

### BACKGROUND OF THE INVENTION

Waterskiing has long been a favored pastime for many people. Recently, alternative water sports, such as wakeboarding have experienced dramatic gains in popularity. Concurrently, technology for enjoying such water sports has advanced as well. Merely by way of example, many boats used for towing skiers, wakeboarders and others have begun to utilize towers of the type described in U.S. Patent Application Publication No. 2004/0144295 A1 and U.S. Pat. No. 5,979,350, of which the entire disclosure of each is incorporated by reference. These towers are generally regarded as providing an enhanced experience for the skier or wakeboarder.

In addition, there have been efforts to provide racks and other apparatus for the storage of equipment such as waterskis, wakeboards and the like. Merely by way of example, U.S. Pat. No. 5,788,133, the entire disclosure of which is incorporated by reference herein, describes a wakeboard rack that can be mounted on a tow pylon of a ski boat, and U.S. Pat. No. 5,788,638, the entire disclosure of which is incorporated by reference herein, describes a combination rack for skis and wakeboards, which can be mounted on the side of a ski boat.

Conventional racks, however, generally are limited in their application to skis and/or wakeboards of specified sizes, and they are ill-adapted to hold other sporting equipment of varying (and especially, of larger) sizes.

### BRIEF SUMMARY OF THE INVENTION

Embodiments of the invention provide improved water sports equipment racks and methods for their use. In an set of embodiments, device (such as a rack, for example) for holding one or more pieces of water sports equipment is provided. The rack might have a first pair of forks having parallel prongs adapted to hold one or more water skis, wakeboards, and or the like. In some embodiments, the rack might further comprise a second pair of forks adapted to hold a surfboard and/or another piece of relatively large equipment. Merely by way of example, each member of the second pair of forks might comprise an upper support surface and a lower support surface disposed approximately parallel with the upper support surface. The upper support surface and lower support surface can be spaces to accommodate a surfboard therebetween. Other embodiments provide methods of using and/or modifying water sports equipment racks.

In some cases, the rack further comprises a coupling mechanism (such as a collar, clamp, etc. adapted to couple the rack with a tower on a ski boat. In various embodiments, the rack features one or more securing mechanisms adapted to secure a surfboard between the upper support surface and the lower support surface. Merely by way of example, a securing mechanism might be a flexible cord fixedly attached to one of the upper and lower support surfaces. The flexible cord might be removably attached to the other of the upper and lower support surfaces. In some cases, the flexible cord is an elastic cord.

Another set of embodiments comprises a surfboard rack adapted to be attached with another rack (e.g. a ski rack, a wakeboard rack, etc.). The surfboard rack might comprise a pair of forks, each fork comprising an upper support surface and a lower support surface. The upper and lower support surfaces may be configured to accommodate a surfboard disposed therebetween. The surfboard rack may have an outer surface adapted to be disposed adjoining a surface of the other rack. The surfboard rack may further comprise one or more attachment devices configured to attach the surfboard rack to the other rack. Such attachment devices can comprise, merely by way of example, attachment hardware (bolts, nuts, screws, and/or the like), adhesives, coupling hardware (coupling collars, bands, and/or the like), etc.

Other embodiments provide methods for using racks, including without limitation the racks described above. Merely by way of example, an exemplary method comprises providing a rack (such one of the racks described above), which might comprise a first support surface and a second support surface. The method might further comprise coupling the rack with a tower on a ski boat, and/or disposing a surfboard between the first support surface and the second support surface.

Another exemplary method comprises providing a first rack, which might be adapted to hold one or more waterskis, wakeboards and/or the like. The method might further comprise attaching a surfboard rack with the first rack to form a combined rack. In some cases, the method will comprise coupling the combined rack with a tower on a ski boat and/or disposing a surfboard between a first support and a second support on the surfboard rack.

The following detailed description together with the accompanying drawings will provide a better understanding of the nature and advantages of the present invention.

### BRIEF DESCRIPTION OF THE DRAWINGS

FIG. 1 is a perspective drawing illustrating a rack for water sports equipment in accordance with various embodiments of the invention.

FIG. 2 is a side view of the rack depicted by FIG. 1.

FIG. 3 is a front view of the rack depicted by FIG. 1.

FIG. 4 is a back view of the rack depicted by FIG. 1.

FIG. 5 is a bottom view of the rack depicted by FIG. 1.

FIGS. 6 and 7 are flow charts illustrating methods of using a rack to store water sports equipment in accordance with various embodiments of the invention.

### DETAILED DESCRIPTION OF THE INVENTION

Embodiments of the invention provide improved water sports racks and methods for their use. In an set of embodiments, a wakeboard rack might have a first pair of forks having parallel prongs adapted to hold one or more water skis, wakeboards, and or the like. In some embodiments, the rack might further comprise a second pair of forks adapted to hold a surfboard (and/or any other suitable piece of equipment, such as a waterski, wakeboard, etc.). Merely by way of example, each member of the second pair of forks might comprise an upper support surface and a lower support surface disposed approximately parallel with the upper support surface. The upper support surface and lower support surface can be spaced to accommodate a surfboard therebetween.

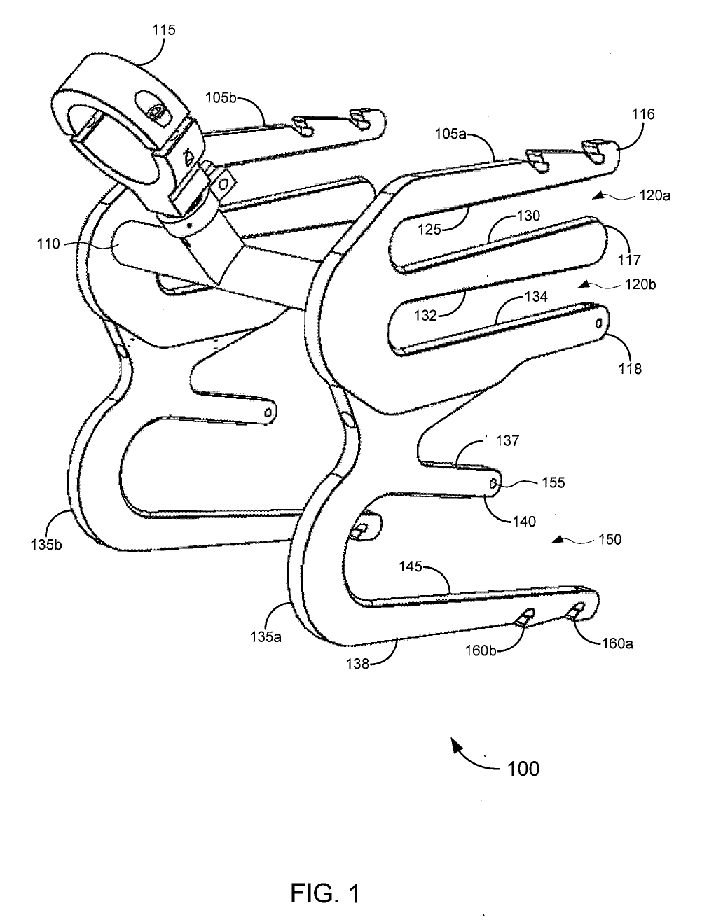

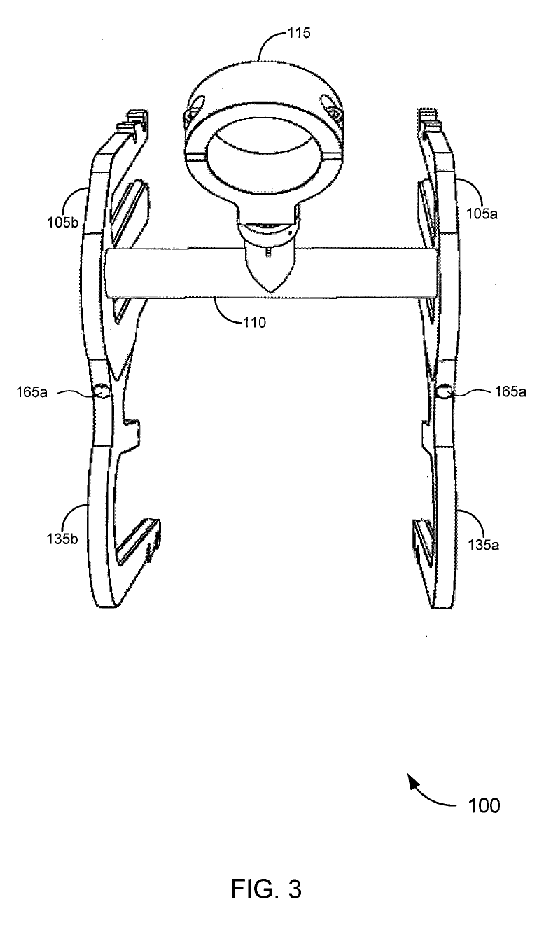

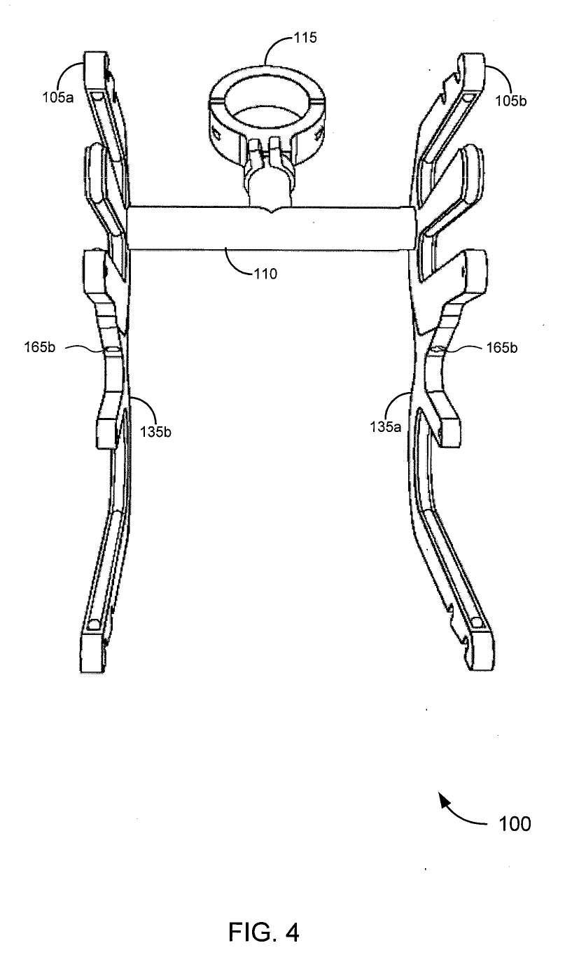

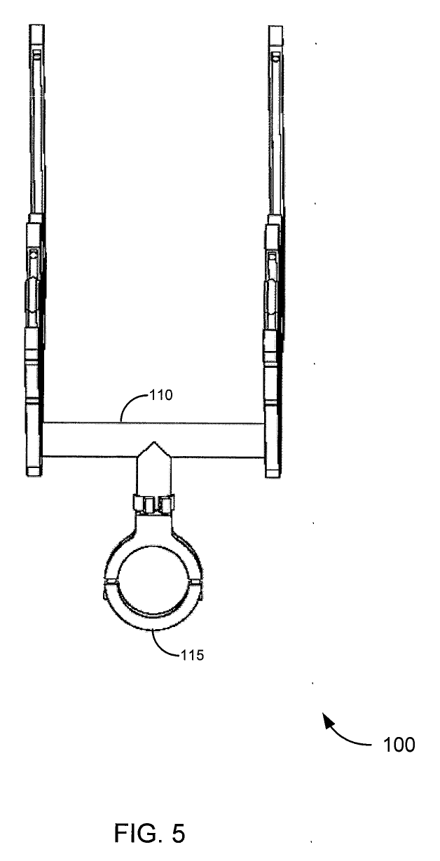

FIGS. 1-5 illustrates a rack 100 for water sports equipment in accordance with various embodiments of the invention. The exemplary rack 100 comprises a first pair of forks 105a, 105b. The forks 105a, 105b are disposed substantially in parallel, and are attached with an cross-member 110 that may disposed roughly perpendicular to the planes of the forks 105a, 105b. (It should be noted that the forks 105a, 105b and the cross-member 110 may be machined, cast and/or otherwise formed as a single element, and/or that they may be formed as separate elements and joined using any suitable attachment method, such as welding, fastners, and/or the like.) The rack 100 further features a coupling mechanism 115, which may be coupled with the cross-member and which can be used to couple the rack 100 with a tower (and/or any other appropriate structure, such as a tow pylon) on a ski boat. Merely by way of example, the coupling mechanism 115 may be a collar, clamp and/or any other apparatus that is configured to attach the rack 100 relatively securely to the tower.

Each of the forks 105a, 105b may comprise a plurality support members that define one or more spaces 120a, 120b. (The number of support members on each fork 105 is discretionary.) Merely by way of example, each fork 105 in the rack 100 of FIG. 1 comprises three support members. The upper support member 116 comprises an upper support surface 125a, and the middle support member 117 comprises a lower support surface 130a. The upper support surface 125a and lower support surface 130a may be disposed so as to define a space 120a sufficient to accommodate a waterski, wakeboard and/or the like. Similarly, the middle support member comprises an upper support surface 132a, and the lower support member 118 comprises a lower support surface 133a, which together define a space 120b, which also may be sufficient to accommodate a waterski, wakeboard, and/or the like. In some cases, the support surfaces 120, 125 might be configured with a relatively soft material, such as a foam, rubber and/or plastic material, which can serve both to minimize the danger of the rack scratching the equipment stored therein and/or to provide enhanced friction between the rack and the equipment.

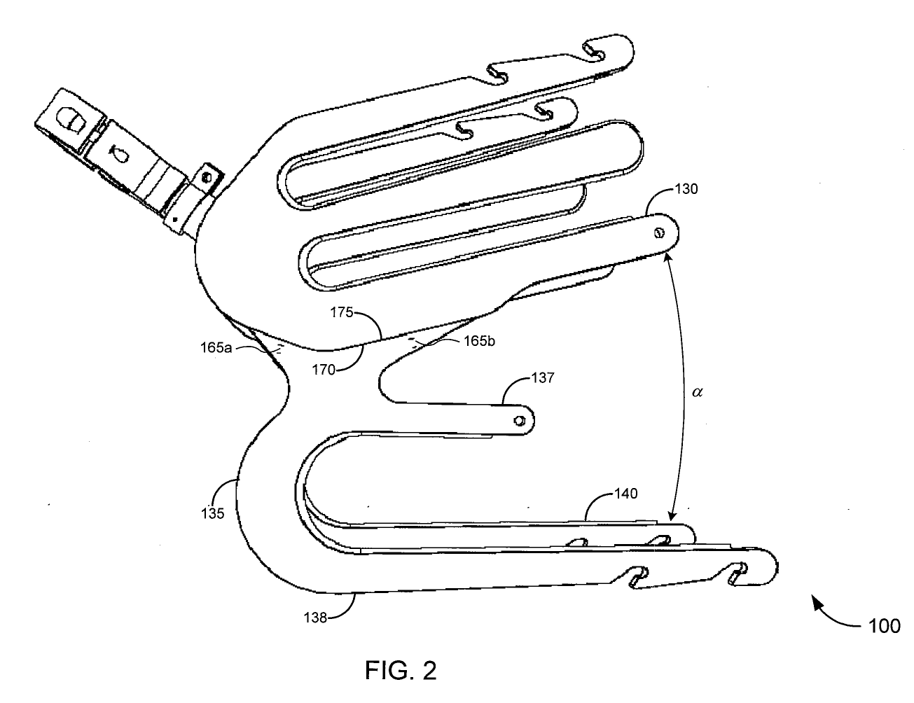

The rack 100 also comprises a second pair of forks 135a, 135b. One of the second pair of forks 135a may be coplanar with one of the first pair of forks 105a, while the other of the second pair of forks 135b may be coplanar with the other of the first pair of forks 105b. Each of the second pair of forks also comprises a plurality of support members. An upper support member 137 may have an upper support surface 140 and a lower support member 138 may have a lower support surface 145. The upper and lower support surfaces 140, 145 may be disposed so as to define a space 150 adapted to hold a surfboard. As illustrated by FIG. 2, the upper and lower support surfaces 140, 145 may further be disposed at an angle α with respect to the support surfaces 125, 130 of the first pair of forks 105, in order to provide clearance for a fin of a surfboard disposed in the space 150 and/or bindings of a wakeboards/waterski disposed in the space 120b, such that the surfboard and the wakeboard may be stored in the rack 100 simultaneously. As described above, the support surfaces 140, 145 might comprise and/or be surfaced with a relatively soft material that contacts the equipment held therein.

In a set of embodiments, the rack 100 may comprise one or more securing mechanisms for securing water sports equipment between various support surfaces of the rack 100. Merely by way of example, each of the second pair of forks 135 may feature a securing mechanism configured to secure a surfboard between the top support surface 140 and the bottom support surface 145. In a set of embodiments, the securing mechanism may comprise a flexible and/or elastic cord configured to span the two support members of a fork 135. The fork 135, then, may comprise a fixed attachment point 155 to which the securing mechanism may be fixedly attached and one or more removable attachment points 160a, 160b to which the securing mechanism may be removably attached. Merely by way of example, in a set of embodiments, the fixed attachment point 155 may be a hole in one of the support members through which a cord may be looped and/or tied, and/or the removable attachment point(s) 160 may be a slot into which a loop of the cord may be inserted, allowing the cord to be fixedly attached at one end and/or removably attached at another end. It should be noted that similar securing mechanisms may be implemented with respect to the first pair of forks 105 as well.

In some embodiments, each of the second pair of forks 135a, 135b may be formed integrally with one of the first pair of forks 105a, 105b. In other embodiments, the second pair of forks 135a, 135b may be separate from the first pair of forks 105a, 105b. In such cases, each of the second pair of forks 135 may comprise one or more attachment devices 165a, 165b that can be used to couple the each of the second pair of forks 135a, 135b to the first pair of forks 105a, 105b, respectively. The attachment devices may comprise any suitable attachment apparatus, including without limitation attachment hardware (bolts, nuts, screws, and/or the like), adhesives, coupling hardware (coupling collars, bands, and/or the like), etc. In some cases, the first pair of forks may be prepared (e.g., by drilling pilot holes, etc.) to receive the attachment devices 165.

As shown on FIG. 2, in some embodiments, an attachment surface 170 of each of the second pair of forks 135 may be configured to be disposed adjacent to an attachment surface 175 of each of the first pair of forks 105, enabling an appropriate attachment of the second pair of forks 135 with the first pair of forks 105. In a set of embodiments, the second pair of forks 135 may be designed to be retrofit to an existing rack that comprises only the first pair of forks 105. Hence, in some cases, one might consider a first rack comprising the first set of forks 105, and the second pair of forks 135 therefore can be considered a second rack that can be attached with the first rack.

The rack 100 may comprise any suitable material, including without limitation, a variety of metals and/or alloys comprising aluminum, steel (perhaps with a water-resistant coating), etc., as well as other suitably-strong materials, which might include high-impact plastic, etc. In some embodiments, the first pair of forks 105 might comprise a first material, and the second pair of forks 135 might comprise a second material. In other embodiments, the first pair of forks 105 and the second pair of forks 135 might comprise the same material.

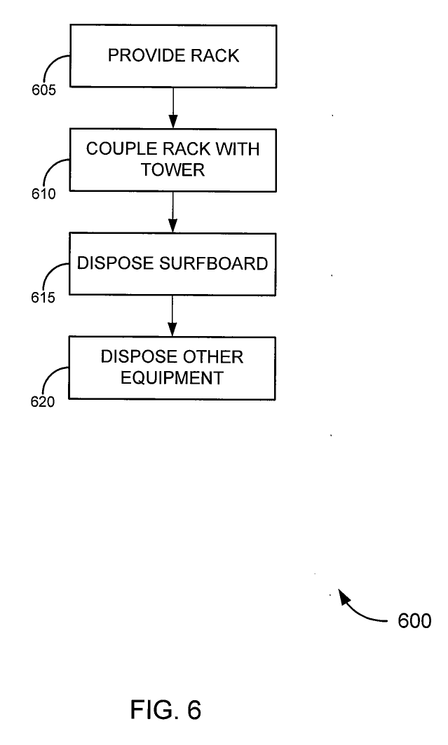

Other embodiments provide methods for using water sports equipment racks, including without limitation the racks described herein. Merely by way of example, an exemplary method 600 illustrated by FIG. 6 comprises providing a rack (such the rack 100 described above), which might comprise a set of support surfaces 140, 145 defining a space to accommodate a surfboard (block 605). The method might further comprise coupling the rack 100 with a tower on a ski boat (block 610), and/or disposing a surfboard in the 150 space defined by the support surfaces 140, 145 (block 615). In further embodiments, the rack might feature another set of support surfaces 125, 130, and the method might comprise disposing another piece of water sports equipment, such as a waterski, a wakeboard, etc. in a space 120 defined by the second set of support surfaces 125b, 130b (block 620).

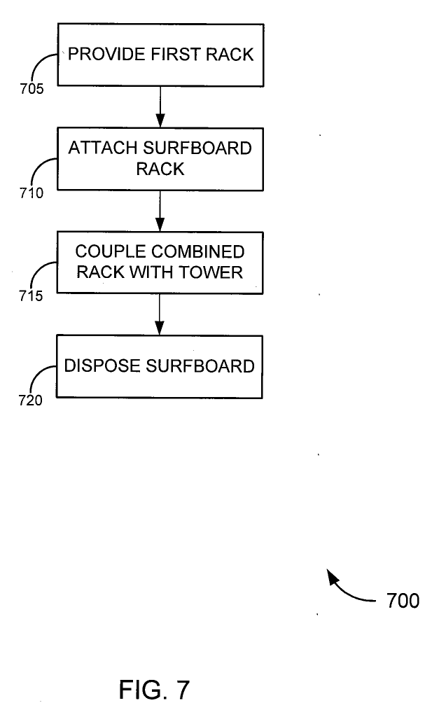

Another exemplary method 700 illustrated by FIG. 7 comprises providing a first rack, which might be adapted to hold one or more waterskis, wakeboards and/or the like (block 705). The method might further comprise attaching a surfboard rack (which might comprise a set of forks 135a, 135b) with the first rack to form a combined rack 100 (block 710). In some cases, the method will comprise coupling the combined rack with a tower on a ski boat (block 715) and/or disposing a surfboard between a first support and a second support on the surfboard rack (block 720).

While the invention has been described with respect to exemplary embodiments, one skilled in the art will recognize that numerous modifications are possible. Merely by way of example, the racks described herein might easily be modified to serve as snowboard racks. For instance, the second pair of forks might be omitted, and the first pair of forks might be modified to accommodate the dimensions of a snowboard. Further, the support surfaces that contact the snowboard(s) might be modified to comprise a material, such as polyurethane, with relatively good cold-weather performance. In addition, the coupling mechanism might be modified to facilitate attachment to a snowmobile and/or other winter recreation vehicle, such as by attachment to a luggage rack on such a vehicle. In some cases, the second pair of forks might be omitted from such a rack.

Thus, although the invention has been described with respect to exemplary embodiments, it will be appreciated that the invention is intended to cover all modifications and equivalents within the scope of the following claims.

What is claimed is:

1. A storage rack for holding at least one piece of water sports equipment in a ski boat having a vertically extending tow tower, the device comprising:
a coupling mechanism adapted to couple the storage rack with the tow tower, such that the storage rack and the at least one piece of water sports equipment is supported by the tow tower;
a cross-member extending from the coupling mechanism;
a first pair of forks comprising a first fork and a second fork, each of the first pair of forks being coupled with the cross-member, the first fork and the second fork extending in parallel planes away from the tow tower, the first fork and second fork each comprising at least a first support member and a second support member, the first support member comprising a first support surface and the second support member comprising a second support surface, wherein the first support surface and the second support surface define a space sufficient to accommodate a piece of water sports equipment; and
a second pair of forks comprising a third fork and a fourth fork, the third fork being attached with the first fork and the fourth fork being attached with the second fork, the third fork and the fourth fork each comprising a third support member and a fourth support member, the third support member defining a third support surface and the fourth support member defining a fourth support surface, wherein the third support surface and the fourth support surface define a second space sufficient to accommodate a surf board.

2. A storage rack as recited in claim 1, wherein the second space defined by the third support surface and the fourth support surface is sufficient to accommodate a plurality of pieces of water sports equipment.

3. A storage rack as recited in claim 1, wherein the third fork is formed integrally with the first fork, and wherein the fourth fork is formed integrally with the second fork.

4. A storage rack as recited in claim 1, wherein the third fork is attached with the first fork using at least a first attachment device, and wherein the fourth fork is attached with the second fork using at least a second attachment device.

5. A storage rack as recited in claim 1, wherein third support surface and the second support surface define an angle sufficient to allow a surfboard to be stored in the second space while another piece of water sports equipment is stored in the first space.

6. A storage rack as recited in claim 1, further comprising a first securing mechanism attached to the third fork, wherein the first securing mechanism is adapted to secure a surfboard in the second space defined by the third support surface and the second support surface.

7. A storage rack as recited in claim 6, wherein the securing mechanism comprises a flexible cord.

8. A storage rack as recited in claim 7, wherein the flexible cord is elastic.

9. A storage rack as recited in claim 7, wherein the flexible cord is fixedly attached to the third support mechanism and removably attached to the fourth support mechanism.

10. A storage rack as recited in claim 6, further comprising a second securing mechanism attached to the fourth fork, wherein the second securing mechanism is adapted to secure a surfboard in the second space defined by the third support surface and the second support surface.

11. A storage rack as recited in claim 6, further comprising a second securing mechanism attached to the first fork, wherein the second securing mechanism is adapted to secure a piece of water sports equipment in the first space defined by the third support surface and the second support surface.

12. A storage rack as recited in claim 1, wherein the at least one piece of water sports equipment comprises a waterski.

13. A storage rack as recited in claim 1, wherein the at least one piece of water sports equipment comprises a wakeboard.

14. A storage rack for holding a surfboard, the storage rack being configured to be attached with a water sports equipment rack comprising a first pair of forks comprising a first fork and a second fork, each of the first pair of forks defining a space sufficient to accommodate a piece of water sports equipment; the storage rack comprising:
a third fork configured to be attached with the first fork;
at least a first attachment device configured to attach the third fork with the first fork;
a fourth fork configured to be attached with the second fork; and
at least a second attachment device configured to attach the fourth fork with the second fork;
wherein the third fork and the fourth fork each comprise a third support member and a fourth support member, the third support member defining a third support surface and the fourth support member defining a fourth support surface, wherein the third support surface and the fourth support surface define a second space sufficient to accommodate a surf board.

15. A storage rack as recited by claim 14, wherein the third fork comprises a first attachment surface that is adapted to be disposed adjoining a surface of the first fork, and wherein the fourth fork comprises a second attachment surface that is adapted to be disposed adjoining a surface of the second fork.

16. A method of storing a piece of water sports equipment, the method comprising:
providing a storage rack for holding at least one piece of water sports equipment, the storage rack comprising:
a) a coupling mechanism adapted to couple the storage rack with a tow tower on a ski boat, such that the storage rack and the at least one piece of water sports equipment is supported by the tow tower;
b) a cross-member extending from the coupling mechanism;
c) a first pair of forks comprising a first fork and a second fork, each of the first pair of forks being coupled with the cross-member, the first fork and the second fork extending in parallel planes away from the tow tower, the first fork and second fork each comprising at least a first support member and a second support member, the first support member comprising a first support surface and the second support member comprising a second support surface, wherein the first support surface and the second support surface define a space sufficient to accommodate a piece of water sports equipment; and
d) a second pair of forks comprising a third fork and a fourth fork, the third fork being attached with the first fork and the fourth fork being attached with the second fork, the third fork and the fourth fork each comprising a third support member and a fourth support member, the third support member defining a third support surface and the fourth support member defining a fourth support surface, wherein the third support surface and the fourth support surface define a second space sufficient to accommodate a surf board;
coupling the storage rack with the tow tower; and
disposing at least one piece of water sports equipment in the first space defined by the first and second support surfaces of the storage rack and/or the second space defined by the third and fourth support surfaces of the storage rack.

17. A method of modifying a water sports equipment rack comprising a first pair of forks comprising a first fork and a second fork, each of the first pair of forks defining a space sufficient to accommodate a piece of water sports equipment; the method comprising:
providing a storage rack comprising:
a) a third fork configured to be attached with the first fork;
b) a fourth fork configured to be attached with the second fork;
wherein the third fork and the fourth fork each comprise a third support member and a fourth support member, the third support member defining a third support surface and the fourth support member defining a fourth support surface, wherein the third support surface and the fourth support surface define a second space sufficient to accommodate a surf board;
attaching the third fork of the storage rack with the first fork of the water sports equipment rack; and
attaching the fourth fork of the storage rack with the second fork of the water sports equipment rack.

18. A method as recited by claim 17, further comprising:
coupling the water sports equipment rack with a tow tower on a ski boat.

19. A method as recited by claim 17, further comprising:
storing a piece of water sports equipment in the second space defined by the third support surface and the fourth support surface.

20. A method as recited by claim 19, wherein the piece of water sports equipment is a surfboard.

21. A method as recited by claim 19, further comprising securing the piece of water sports equipment with a securing mechanism.

22. A method as recited by claim 17, further comprising:
storing a piece of water sports equipment in the first space defined by the first support surface and the second support surface.
